(19) United States
(12) Patent Application Publication
(10) Pub. No.: US 2008/0101201 A1
(43) Pub. Date: May 1, 2008

(54) Optical Pickup Device

(75) Inventor: Hirokatsu Nagatake, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Saitama (JP)

(21) Appl. No.: 11/547,081

(22) PCT Filed: Mar. 9, 2005
(86) PCT No.: PCT/JP05/04583

§ 371 Date: Sep. 29, 2006

(30) Foreign Application Priority Data
Mar. 31, 2004 (JP) 2004-104573

(51) Int. Cl. G11B 7/135

(52) U.S. Cl. 369/112.02

(57) ABSTRACT

The object of the present invention is to eliminate a broadband wavelength plate and to reduce a burden imposed on a manufacture and design of an optical pickup device.

According to the present invention, a function of a liquid crystal panel 170 is changed in accordance with wavelengths of laser beams employed. That is, for a laser beam having a short length (a laser beam with a wavelength band of 660 nm for DVD), a liquid crystal panel 170 is used as an aberration correction device, and for light having a long waveform (a laser beam with a wavelength band of 785 nm for CD), the liquid crystal panel 170 is used as a wavelength plate for converting a polarized state. By being passed through the liquid crystal panel 170, the laser beam with the wavelength band of 785 nm for CD is changed to elliptically polarized light, and by being further passed through a quarter-wave plate 180, specialized for a laser beam with the wavelength band of 660 nm for DVD, is finally changed to circularly polarized light.

### TECHNICAL FIELD

The present invention relates to an optical pickup device that can record or reproduce information on different types of optical recording media.

### BACKGROUND ART

An optical pickup device is a device wherein, to record or erase information, a laser beam emitted by a semiconductor laser is condensed by an object lens at the signal recording face of an optical disk, and wherein, to reproduce information, light reflected by the optical disk (returned light) is detected by a photodetector.

Recently, CDs (Compact Disks) and DVDs (Digital Video Disks or Digital Versatile Disks) have been widely employed as optical recording media (photonic recording medium), and therefore, it is preferable that a single optical pickup device be employed to record or reproduce information both on CDs and on DVDs.

In order to be able to record or reproduce information both on a CD and on a DVD, a laser source corresponding to each medium must be prepared for the optical pickup device.

An infrared semiconductor laser is employed for a CD, and the wavelength of a laser beam to be emitted is about 785 nm. Further, since the recording density for a DVD is greater than that for a CD, an infrared laser beam having a shorter wavelength is employed. The wavelength of the laser beam is about 660 nm.

FIG. 1 is a diagram showing the arrangement of the essential portion of an optical pickup device (an optical pickup device that can record/reproduce information both on a CD and on a DVD) that was considered by the inventor of the present invention.

As is shown, this optical pickup device includes: a DVD light source 10, a CD light source 20, a collimator lens 40, a liquid crystal panel 50 used for aberration correction, and a quarter-wave plate 60.

The DVD light source 10 emits a P-polarized laser beam (i.e., linearly polarized light wherein an electric field is vibrated in the incident plane) with a wavelength band of 660 nm. The CD light source 20 emits a P-polarized laser beam with a wavelength band of 785 nm.

The liquid crystal panel 50 is provided in order to correct a wavefront aberration (mainly, a coma aberration) caused by the tilt (the tilt angle) of a DVD disk.

That is, since the recording density of a DVD is high and the wavelength of the laser beam is short, a margin is small for the angle (the tilt angle) at which the DVD disk is inclined in a direction perpendicular to the light axis of the optical pickup. Thus, when only a small DVD disk tilt occurs, a wavefront aberration (coma aberration) occurs.

In short, an aberration (a phenomenon, occurring in a system wherein an image is formed using an optical system, that causes an actual image forming point to be shifted away from the ideal image forming point) occurs because the optical path length is changed due to the tilting or warping of a disk.

By applying a voltage to a liquid crystal device, the twisted state of molecules in the liquid crystal can be altered. This indicates that the length of the optical path for incident light can be changed by the application of a voltage. By making use of the effect, a voltage applied to liquid crystal can be adjusted to suppress a change in the length of the optical path, which is the result, for example, of the inclination of a disk. Then, correction of an aberration can be performed.

Although not illustrated, the lower electrode of the liquid crystal panel 50 is divided into a plurality of electrode patterns and a voltage applied to each electrode pattern is controlled exactly, and the twisted state of the liquid crystal molecules is partially controlled. In this manner, an aberration can be corrected.

Further, in FIG. 1, the P-polarized light (linearly polarized light) with the wavelength band of 660 nm for DVD and the P-polarized light with the wavelength band of 785 nm for CD enter the liquid crystal panel 50, in the state where the polarization plane matches the long axial direction of the liquid crystal molecules of the liquid crystal panel 50.

Therefore, the linearly polarized light advances along the twisted shape of the TN liquid crystal (the TN liquid crystal may not be twisted, depending on the voltage applied), and is again output as linearly polarized light (P-polarized light in this case).

The quarter-wave plate 60 is a polarized light control device for converting linear polarized light into circularly polarized light (or for performing a reserve conversion).

That is, when 45° is set as an angle formed between the polarization plane of linearly polarized light (P-polarized light) that enters the quarter-wave plate 60 and the optical axis of the quarter-wave plate, the laser beam output by the quarter-wave plate 60 becomes circularly polarized light.

This circularly polarized light serves as light for recording/reproducing for a CD and a DVD. It should be noted that there is a case where the linearly polarized light is employed as light for recording or reproducing. In this case, however, a recording/reproducing jitter performance would be deteriorated due to discrepancies in disks, and thus, it is preferable that circularly polarized light be employed.

Further, the quarter-wave plate 60 in FIG. 1 needs to convert, into circularly polarized light, both a laser beam (linearly polarized light) with the wavelength band of 660 nm for DVD and a laser beam (linearly polarized light) with the wavelength band of 785 nm for CD. Therefore, a broadband quarter-wave plate has to be employed as the quarter-wave plate 60 in FIG. 1.

The broadband quarter-wave plate is a composite phase difference plate constituted by laminating, for example, a plurality of polymer films having different optical anisotropies.

An optical pickup device that can record/reproduce information both on a CD and on a DVD and that includes an arrangement wherein a liquid crystal panel for aberration correction and a broadband quarter-wave plate are provided is described, for example, in patent document 1. Further, the broadband quarter-wave plate is described, for example, in patent document 2.

Patent Document 1: JP-A-10-20263 (FIG. 1)

Patent Document 2: JP-A-2003-14931

The broadband quarter-wave plate is a composite phase plate, which is not easily manufactured and is expensive. This becomes a burden for the manufacture of the optical pickup device.

Furthermore, for the broadband quarter-wave plate, accurate conversion is required for the polarized states of laser beams having a plurality of wavelengths, and considerably strict restrictions (e.g., the thickness of a wavelength plate, the position where the wavelength plate is located) are imposed on the usage. Therefore, the degree of freedom for a design of the optical pickup device is reduced.

### DISCLOSURE OF THE INVENTION

One problem to be solved by the present invention is, for example, to eliminate a broadband wavelength plate and to reduce a burden on a design and manufacturing of an optical pickup device because of its manufacture.

In order to resolve this problem, an optical pickup device for the present invention, which is capable of recording or reproducing information on first and second optical recording mediums that are different in types with each other is characterized by including: first and second light sources that emit lights having different wavelengths each other; a liquid crystal device that serves as an aberration correction device to the light emitted from the first light source and that serves as a wavelength plate to the light emitted from the second light source; and a wavelength plate whose main purpose is to convert a polarized state of the light emitted from the first light source and passed through the liquid crystal device that serves as the aberration correction device.

### BRIEF DESCRIPTION OF THE DRAWINGS

FIG. 1 is a diagram showing an arrangement of an essential portion of an optical pickup device (an optical pickup device that can record/reproduce information on both a CD and a DVD) that was considered by the inventor of the present invention;

FIG. 2 is a diagram showing a general arrangement of an optical pickup device according to one mode of the present invention;

FIG. 3 is a diagram showing the polarized state of a laser beam in the main portion of the optical pickup device in FIG. 2;

FIG. 4 is a diagram for explaining the optical characteristics of a liquid crystal device; and

FIG. 5 is a diagram for explaining the function of the liquid crystal device that serves as a wavelength plate.

It should be noted that, in the drawings, reference numeral 100 denotes a DVD laser source; 110, a CD laser source; 120, a polarized light beam splitter; 130, a condensing lens; 140, a photo diode (photoelectric conversion device); 150, a dichroic prism; 160, a collimator lens; 170, a liquid crystal panel; 180, a quarter-wave plate (a single wavelength plate optimized for a DVD laser beam); 190, an object lens; 200, an optical recording medium; 210, a tilt angle detector; and 220, a liquid crystal panel control circuit.

### BEST MODE FOR CARRYING OUT THE INVENTION

One mode of the present invention will now be described while referring to the drawings.

An optical pickup device according to the mode of this invention is characterized in that, for a DVD laser beam, a liquid crystal panel serves as an aberration correction device, and for a CD laser beam, serves as a wavelength plate for changing a polarized state.

That is, since a DVD disk has a high recording density and a short wavelength for a recording or reproducing laser beam, a tilt margin is not sufficient, and thus, a liquid crystal device must be appropriately employed to perform an aberration correction (tilt correction).

On the other hand, since a CD has a low recording density and a long wavelength for a laser beam, a tilt margin is sufficient.

Therefore, it is satisfactory so long as the aberration correction (tilt correction) is performed during the recording and reproducing for a DVD, and the aberration correction is not required for a CD.

Further, liquid crystal is a material that provides. various optical effects, and depending on the use condition that is selected, the liquid crystal also provides such effects as a wavelength plate (phase difference plate).

The pickup device in this mode focuses on the above two points, and for the recording and reproducing for a CD, aberration correction using a liquid crystal device is not performed, and instead, the liquid crystal device serves as a wavelength plate that converts linearly polarized light into elliptically polarized light (or circularly polarized light).

Therefore, a quarter-wave wavelength plate arranged after the liquid crystal device need convert the polarized state only for a DVD laser beam, and thus, only a single wavelength plate is required to cope with the conversion (i.e., a broadband wavelength plate is not required).

Thus, for this mode, an optical pickup device can be easily assembled by using inexpensive parts.

Additionally, a wavelength plate employed for this mode is not a composite product, but a single wavelength plate, so that the thickness of a wavelength plate and the location of the wavelength plate, for example, can be selected more freely, and the degree of freedom of the design can be increased.

The mode for this invention will be described in more detail.

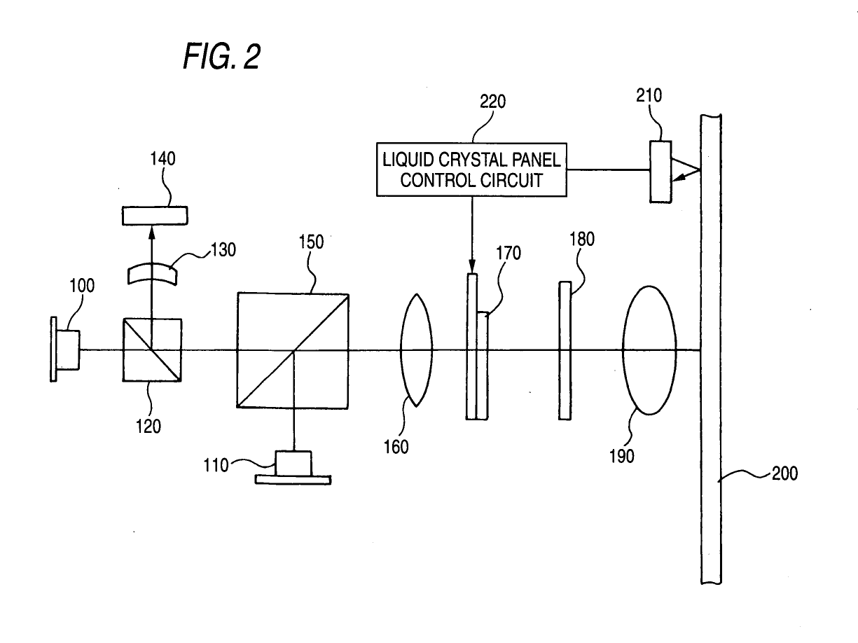

FIG. 2 is a diagram showing a general arrangement of the optical pickup device according to the mode of the present invention.

As illustrated, this optical pickup device includes: a DVD laser source 100; a CD laser source 110; a polarized beam splitter 120; a condenser lens 130; a photodiode (photoelectric conversion device) 140, which converts light reflected by disks (DVD and CD) into electric signals; a dichroic prism 150; a collimator lens 160; a liquid crystal device (having functions both for an aberration correction device and for a wavelength plate); a quarter-wave plate 180, which is designed to perform, as its main purpose, the conversion of a DVD laser beam (linearly polarized light) into circularly polarized light; an object lens 190; an optical recording medium (a disk, such as a CD or a DVD) 200; a disk tilting (tilt angle) detector 210; and a liquid panel control circuit 220.

The DVD laser source 100 emits a P-polarized laser beam with a wavelength band of 660 nm (i.e., linearly polarized light such that the electric field vibrates in the incidence plane). The CD laser source 110 emits a P-polarized laser beam with a wavelength band of 785 nm.

The quarter-wave plate 180 is a plate for converting a laser beam (linearly polarized light) with the wavelength band of 660 nm into circularly polarized light, and is not a broadband wavelength plate.

That is, the quarter-wave plate 180 in this mode is designed so that a phase difference between the advanced phase and the delayed phase of a laser beam with the wavelength band of 660 nm is an odd number times π/4.

The laser beam emitted by each laser beam (100, 110) has an optical axis used in common, and each laser beam advances through the dichroic prism 150, the collimator lens 160, the liquid crystal device, the quarter-wave plate 180 and the object lens 190, and forms an image on the recording face of the disk 200.

Further, light reflected by the disk 200 advances in the reverse direction and, by the polarized beam splitter 120, the forward direction of the light is bent, at a right angle, and an image is formed on the photodiode 140 via the condenser lens 130.

It should be noted that means for bending the forward direction of the reflected light is not limited to the polarized beam splitter 120, and need only be means for which there is a prism function.

When a DVD is employed as an optical recording medium, the liquid crystal panel 170 serves as an aberration correction device.

That is, since a DVD has a high recording density and has a short wavelength for a laser beam, only a small margin is present for an angle (a so-called tilt angle) at which the DVD disk is tilted in a direction perpendicular to the light axis of the optical pickup, so that a wavefront aberration (a coma aberration) will occur when only a small tilting of the DVD disk occurs.

In short, an aberration (a phenomenon in which an actual image forming point is shifted away from the ideal image forming point in a system that forms an image by an optical system) occurs because an optical path length is changed due to the tilting or warping of a disk.

By applying a voltage to a liquid crystal device, the twisted state of the liquid crystal molecules can be changed. This indicates that the length of an optical path for incident light can be changed by applying a voltage. By making use of this effect, a voltage applied to liquid crystal can be adjusted so as to suppress a change in the length of the optical path that is induced, for example, by the inclination of the disk 200. Then, a correction of an aberration can be performed.

Although not shown, the lower electrode (transparent electrode made of ITO (indium tin oxide)) of the liquid crystal panel 170 is divided into a plurality of electrode patterns and a voltage applied to each electrode pattern is controlled by the liquid crystal panel control circuit 220, and the oriented state of the liquid crystal molecules of the liquid crystal panel 170 is controlled. In this manner, an aberration can be corrected.

Therefore, during the recording and reproducing for a DVD, a voltage applied at both ends of the liquid crystal panel 170 is dynamically changed by the liquid crystal control circuit 220.

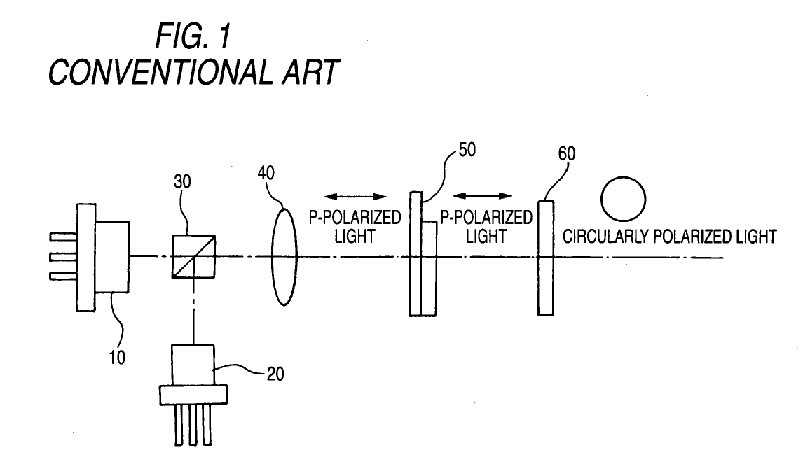

The operation during the recording and reproducing for a DVD is performed in the same manner as that referred to in FIG. 1.

That is, during the recording and reproducing for a DVD, the polarization direction of the P-polarized light (linearly polarized light) with a wavelength band of 660 nm for DVD matches the long axial direction of the liquid crystal molecules of the liquid crystal panel 170. Thus, linearly polarized incident light is emitted as linearly polarized light.

The quarter-wave plate 180 is a single wavelength plate that converts the linearly polarized light with the wavelength band of 660 nm for DVD into circularly polarized light.

By being passed through the quarter-wave plate 180, a DVD laser beam is changed to circularly polarized light, which is used as light for the recording and reproducing for the disk (DVD disk) 200.

On the other hand, for a CD laser beam (a laser beam with a wavelength band of 785 nm) emitted by the CD laser source 110, the liquid crystal panel 170 serves as a wavelength plate.

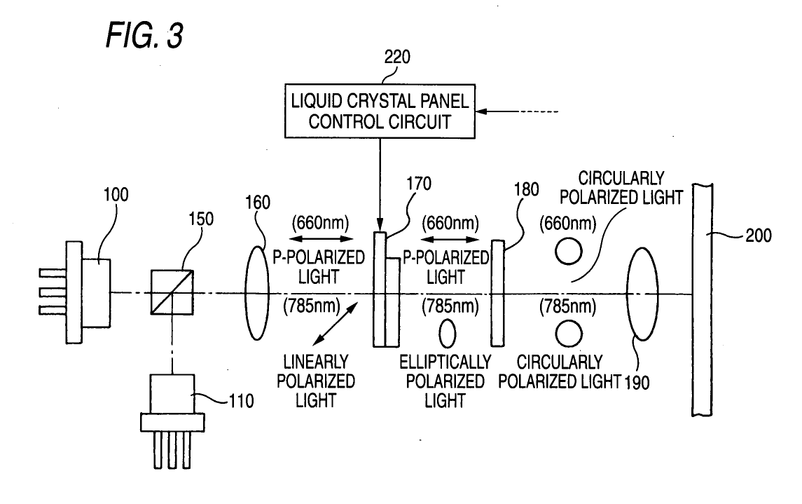

An explanation for this will be given while referring to FIGS. 3 to 5.

FIG. 3 is a diagram showing the polarized state of a laser beam in the main portion of the optical pickup device in FIG. 2.

In FIG. 3, (660 nm) represents a laser beam with a wavelength band of 660 nm for DVD, and similarly, (785 nm) represents a laser beam with a wavelength band of 785 nm for CD.

Further, arrows represent linearly polarized lights, ellipses represent elliptically polarized lights, and circles represent circularly polarized lights.

As described above, for a laser beam with the wavelength band of 660 nm for DVD, the polarized state is the same as that shown in FIG. 1.

On the other hand, the polarized state of the laser beam with the wavelength band of 785 nm for CD in FIG. 3 differs from that shown in FIG. 1.

That is, a laser beam with the wavelength band of 785 nm, emitted by the CD laser source 110, enters the liquid crystal panel 170, while the polarization plane is adjusted so that the polarization plane is set at a predetermined angle θ (0<θ<90°) relative to the long axial direction of the liquid crystal molecules of the liquid crystal panel 170.

At this time, the control voltage for the liquid crystal panel 170 is fixed (i.e., the aberration control that is provided during the recording and reproducing for a DVD is not performed).

Furthermore, the thickness of the liquid crystal panel 170 is adjusted in advance so that a predetermined retardation can be obtained. Thus, as will be described later, the liquid crystal panel 170 serves as a wavelength plate, and as a result, the polarized state of the CD laser beam that has passed through the liquid crystal panel 170 is that of elliptically polarized light.

When this elliptically polarized light is passed through the quarter-wave plate 180 that is optimized for a DVD laser beam, the polarized state is changed by subjecting an optical action from the quarter-wave plate 180, and circularly polarized light is finally obtained. This circularly polarized light serves as the light for the recording and reproducing for the disk (CD) 200.

Conversely, the thickness of the liquid crystal panel 170 (and the incidence angle θ of a laser beam) is adjusted in advance, so that the polarized state of light passed through the quarter-wave plate 180 is changed to circularly polarized light.

The function of the liquid crystal device as a wavelength plate will now be described.

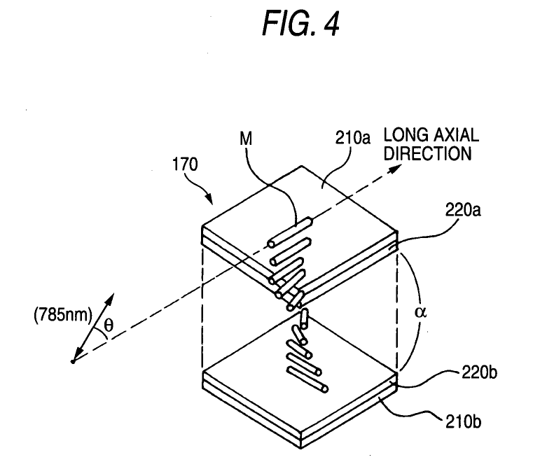

FIG. 4 is a diagram for explaining the optical properties of the liquid crystal panel (the liquid crystal device).

As illustrated, the liquid crystal panel (the liquid crystal device) is constituted by upper and lower glass plates 210a, 210b; transparent electrodes 220a, 220b made of ITO; and liquid crystal modules M that are twisted at a predetermined angle (the molecules may not be twisted, depending on the voltage applied).

The liquid crystal molecules include biphenyl and multiple bond portions in the long axial direction, and the permittivity differs between in the long axial direction and in the perpendicular direction (i.e., the short axial direction). According to a liquid crystal phase, molecules statistically turn to a direction indicated by an orientation vector, and an anisotropy is indicated by using this direction and the perpendicular direction. A refractive index differs in the direction parallel to the orientation vector and in the direction perpendicular to the orientation direction. Thus, for light entering a liquid crystal cell, refractive indexes are different between the direction of rays and the direction of polarization.

However, the anisotropy of the refractive index is not present for a ray that advances in the direction indicated by the orientation vector, and there is only one refractive index, regardless of the polarization direction. This direction is called the light axis of an anisotropic crystal. A general nematic crystal has only one light axis, and is called a uniaxial material.

Assume that light perpendicular to the light axis (i.e., the long axial direction of the liquid crystal molecules) enters the uniaxial material (i.e., the liquid crystal), and that ne denotes the refractive index for light on the vibration plane parallel to the light axis and that no denotes the refractive index for light perpendicular to the light axis. Further, light on the vibration plane parallel to the light axis is called abnormal light (rays) and light on the vibration plane perpendicular to the light axis is called normal light (rays). The refractive index is a constant, no, for the normal light, regardless of the incidence angle of light, and the normal light is bent in accordance with Snell's law. The refractive index for abnormal light varies from ne to no, depending on the incidence angle. Therefore, the abnormal light does not seem to follow Snell's law and move abnormally.

Suppose that linearly polarized light is to be passed perpendicularly through the light axis of the uniaxial material. This corresponds to a case where light perpendicularly enters a liquid crystal device having the horizontal orientation of liquid crystal (i.e., a case where for the laser beam there is an angle θ=90° relative to the long axial direction of the liquid crystal molecules). When polarized light is parallel to or perpendicular to the light axis, the polarized light, as maintained, is linearly polarized. Polarized light, the state of which is not changed, even when the light is passed through a material, is called intrinsic polarized light.

On the other hand, a case (a case where 0<θ<90° is satisfied) in which the polarization plane of incident linearly polarized light is neither parallel nor perpendicular to the light axis (the long axis of the liquid crystal molecules), the polarized state is changed as light passes through the liquid crystal. In general, polarized light is transmitted as two intrinsic polarized light rays that intersect in a material. At this time, since the refractive indexes differ because of the directions of polarization, a phase difference Δ, expressed by

Δ=2πd(ne−no)/λ,

occurs after the rays have passed through the liquid crystal device.

In this case, λ denotes the wavelength of incident light, and d denotes the thickness of a liquid crystal device. When the incident polarized light is at an angle of 45° relative to the light axis, the phase difference Δ is π/4, and light that passes through the liquid crystal becomes circularly polarized light. But when incident polarized light is shifted slightly, the phase difference Δ is π and the light becomes linearly polarized light, perpendicular to the incident polarized light. When the dispersion of liquid crystal is ignored, retardation R can be expressed by;

R=d(ne−no)=Δnd.

That is, liquid crystal has the same optical property as has the uniaxial crystal material, and by adjusting the thickness d of the liquid crystal, the phase difference can be controlled, between the advanced phase and the delayed phase, for the light that passes through the liquid crystal. Thus, the polarized state of the laser beam emitted by the liquid crystal can be controlled.

According to this mode, as previously described, the thickness d of the liquid crystal panel 170 (and the incidence angle θ of the laser beam) is adjusted in advance, so that the polarized state of light with the wavelength band of 785 nm, which has passed through the quarter-wave plate 180, becomes that of circularly polarized light.

That is, in this mode, as shown in FIG. 3, light that passes through the liquid crystal panel 170 becomes elliptically polarized light, and when this elliptically polarized light passes through the quarter-wave plate 180, the light is finally changed to circularly polarized light.

It should be noted that when an optical path along which light does not pass through the quarter-wave plate 180 can be obtained for a laser beam with the wavelength band of 785 nm, circularly polarized light may be employed as a laser beam output by the liquid crystal panel 170, and may be employed as light for recording and reproducing.

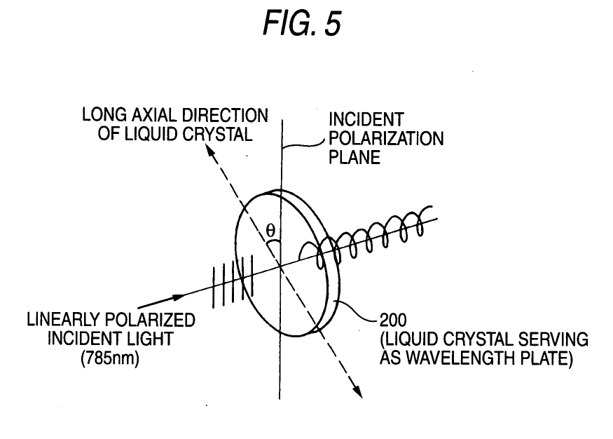

FIG. 5 is a diagram showing the function of the liquid crystal panel (a liquid crystal device) as a wavelength plate.

As illustrated, for a laser beam with the wavelength band of 785 nm for CD, the liquid crystal panel 170 functions like a wavelength plate that converts linearly polarized light into elliptically polarized light or circularly polarized light.

As described above, in the optical pickup device for this mode, the function of the liquid crystal panel is changed in accordance with the wavelength of the laser beam that is employed (i.e., the liquid crystal panel is used as an aberration correction device for light having a short wavelength, and is used as a wavelength plate for light having a long wavelength). Therefore, the burden imposed on the quarter-wave plate arranged following the liquid crystal panel is reduced, and as a result, an inexpensive wavelength plate can be employed.

Thus, for this mode, an optical pickup device can be easily assembled by using inexpensive parts.

Furthermore, the wavelength plate employed for this mode is not a composite product but is a single wavelength plate, so that the thickness of the wavelength plate and the location of the wavelength plate, for example, can be more freely selected, and the degree of freedom for a design can be increased.

Therefore, according to the present invention, a broadband wavelength plate is not required, and the burden imposed on the manufacture and design of an optical pickup device can be reduced.

In the above explanation, a CD and DVD compatible optical pickup device as been employed as an example; however, the present invention is not limited to this.

For example, recently, an optical pickup device that employs a blue laser beam (a blue ray) having a shorter wavelength has appeared, and as the density of an optical recording medium is increased, problems, such as an increase in the cost of optical parts and the reduction of the degree of freedom of design, are revealed.

In this case, when a method is employed whereby, based on the design idea of the present invention, the function of an optical part is performed according to the wavelength of the light that is used, a burden that accompanies the manufacture and assembly of the optical pickup device can be reduced.

The present invention can be employed, for example, for a DVD/CD compatible drive, a DVD recorder or another disk drive and for a drive for a medium, such as a magneto-optical recording medium (MO), that uses light.

The present invention is based on Japanese Patent Application (P2004-104573), filed on Mar. 31, 2004, and the contents thereof are incorporated by a reference in this specification.

1. An optical pickup device that is used for recording or reproducing information on first and second optical recording mediums that are different in types with each other, the optical pickup device comprising:
a first light source that emits a first light with a first wavelength;
a second light source that emits a second light with a second wavelength that is different from the first wavelength;
a liquid crystal device that serves as an aberration correction device that corrects an aberration of the first light, and serves as a first wavelength plate that controls a polarization of the second light; and
a second wavelength plate that controls a polarization of the first light that passed through the liquid crystal device.

2. The optical pickup device according to claim 1,
wherein a polarization plane of the first light is consistent with a long axial direction of molecules of the liquid crystal device; and
wherein a polarization plane of the second light is configured to form a predetermined angle θ (0<θ<90°) relative to the long axial direction of the molecules of the liquid crystal device.

3. The optical pickup device according to claim 2,
wherein the first light emitted from the first light source is a linearly polarized light, and enters the liquid crystal device so that the polarization plane of the first light is consistent with the long axial direction of the molecules of the liquid crystal device,
wherein the first light output from the liquid crystal device is transmitted to the second wavelength plate and is converted into a circularly polarized light that is employed for recording or reproducing information on the first optical recording medium,
wherein the second light emitted from the second light source is a linearly polarized light, and enters the liquid crystal device so that the polarization plane of the second light is configured to form the predetermined angle θ (0<θ<90°) relative to the long axial direction of the molecules of the liquid crystal device,
wherein the second light output from the liquid crystal device is an elliptically polarized light and is transmitted to the wavelength plate, and is converted into a circularly polarized light that is employed for recording or reproducing information on the second optical recording medium.

4. The optical pickup device according to claim 3, wherein a thickness of the liquid crystal device is adjusted so that the second light is converted into the circularly polarized light after the second light passes the second wavelength plate for recording or reproducing information on the second optical recording medium.

5. The optical pickup device according to claim 1, wherein the first wavelength is shorter than the second wavelength.

6. The optical pickup device according to claim 1, wherein the first light is for recording or reproducing information on a DVD, and the second light is for recording or reproducing information on a CD.
